(19) United States
(12) Patent Application Publication
(10) Pub. No.: US 2025/0116848 A1
(43) Pub. Date: Apr. 10, 2025

(54) OPTICAL SYSTEM

(71) Applicant: TDK TAIWAN CORP., Taoyuan City (TW)

(72) Inventors: Wei-Jhe SHEN, Taoyuan City (TW); Po-Xiang ZHUANG, Taoyuan City (TW); Yi-Ho CHEN, Taoyuan City (TW); Sin-Jhong SONG, Taoyuan City (TW)

(21) Appl. No.: 18/906,682

(22) Filed: Oct. 4, 2024

Related U.S. Application Data
(60) Provisional application No. 63/588,441, filed on Oct. 6, 2023.

(51) Int. Cl. G02B 13/00; G02B 7/18; G02B 27/64

(52) U.S. Cl. CPC G02B 13/0065; G02B 7/1805; G02B 27/646

(57) ABSTRACT

An optical system is provided. The optical system includes a first optical module, a base and a first optical unit. The first optical module is configured to connect a first optical element. The first optical module is connected to the base, unit is disposed on the base.

### CROSS REFERENCE TO RELATED APPLICATIONS

This application claims the benefit of U.S. Provisional Application No. 63/588,441, filed Oct. 6, 2023, the entirety of which is incorporated by reference herein.

### BACKGROUND OF THE INVENTION

### Field of the Invention

The present invention relates to an optical system, and, in particular, to a periscope optical system.

### Description of the Related Art

With technological advancements, many modern electronic devices (such as smartphones) are now equipped with photography or video recording functions. The demand for these electronic devices is steadily increasing, and they are being developed with a focus on becoming lighter, thinner, and more high-performing to provide users with more convenient and versatile options.

The aforementioned electronic devices with photography or video recording functions often adopt periscope lens technology to achieve higher optical zoom levels while maintaining a slim and lightweight profile. The periscope lens uses prisms or mirrors to refract light into a horizontal path, thus extending the focal length and achieving high-magnification zoom without protruding the lens from the casing of the device. This design not only allows light to pass through optical elements to form an image on the image sensor but also effectively reduces the thickness of the module. As mobile devices increasingly demand miniaturization and durability, periscope lenses have become an important technological solution in optical design for enhancing imaging performance and reducing volume.

### BRIEF SUMMARY OF THE INVENTION

Embodiments of the present disclosure provide an optical system. The optical system includes a first optical module, a base and a first optical unit. The first optical module is configured to connect a first optical element. The first optical module is connected to the base. The first optical unit is disposed on the base.

In some embodiments, the first optical module includes a first movable portion, a first base and a first circuit component. The first movable portion is configured to connect the first optical element. The first movable portion is movable relative to the first base. The first circuit component is configured to electrically connect an external circuit. The first circuit component includes a movable portion fixed end, a fixed portion fixed end and a flexible portion. The movable portion fixed end is movable relative to the first base. The movable portion fixed end is movable relative to the fixed portion fixed end. The movable portion fixed end is movably connected to the fixed portion fixed end via the flexible portion.

### BRIEF DESCRIPTION OF THE DRAWINGS

Embodiments of the present disclosure is described in detail below with reference to the accompanying drawings. It should be noted that, in accordance with standard industry practices, various features are not drawn to scale and are provided for illustrative purposes only. In fact, the sizes of components may be arbitrarily enlarged or reduced to clearly depict the features of the present disclosure.

FIG. 1 shows a perspective view of an optical system according to some embodiments of the present disclosure.

FIG. 2 shows an exploded view of the optical system according to some embodiments of the present disclosure.

FIG. 3 shows a cross-sectional view of the optical system taken along line A-A of FIG. 1.

FIG. 4 shows a cross-sectional view of the optical system, in which the light path entering the optical system is indicated by arrows.

FIG. 5 shows a perspective view of the optical system according to some embodiments of the present disclosure, with a housing shown in dashed lines for illustrative purposes.

FIG. 6 shows a cross-sectional view of the optical system taken along line B-B of FIG. 1.

FIG. 7 shows a cross-sectional view of the optical system taken along line C-C of FIG. 1.

### DETAILED DESCRIPTION OF THE INVENTION

Unless otherwise defined, all terms used herein (including technical and scientific terms) have the same meaning as commonly understood by one of ordinary skill in the art. It is to be understood that such terms, for example, those defined in commonly used dictionaries, should be interpreted as having meanings consistent with the context of the relevant technology and this disclosure, and should not be interpreted in an idealized or overly formal sense unless specifically defined herein.

Furthermore, ordinal terms such as “first,” “second,” etc., used in the specification and claims to modify elements do not inherently imply any prior numerical order of these elements, nor do they indicate the sequence of one element relative to another or the order in a manufacturing process. The use of these ordinal terms is solely to distinguish one element with a certain designation from another element with the same designation.

In addition, in some embodiments of this disclosure, terms related to joining or connecting, such as “connected” or “interconnected,” unless specifically defined otherwise, can refer to two structures being in direct contact or two structures not in direct contact with other structures located between them. Furthermore, these terms may encompass situations where both structures are movable or both structures are fixed.

In the descriptions of this specification, references to terms such as “one embodiment,” “some embodiments,” “an example,” etc., mean that the specific features, structures, materials, or characteristics described in connection with that embodiment or example are included in at least one embodiment or example of the present disclosure. Throughout this specification, the illustrative references to the aforementioned terms are not necessarily directed to the same embodiment or example. Moreover, the specific features, structures, materials, or characteristics described may be combined in any suitable manner in one or more embodiments or examples. Additionally, those skilled in the art may join and combine different embodiments or examples described in this specification.

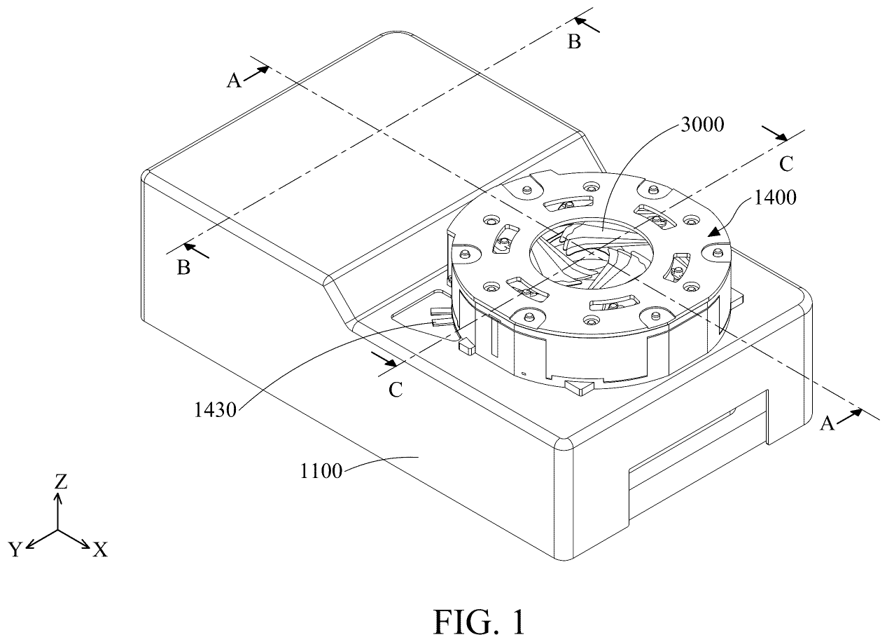

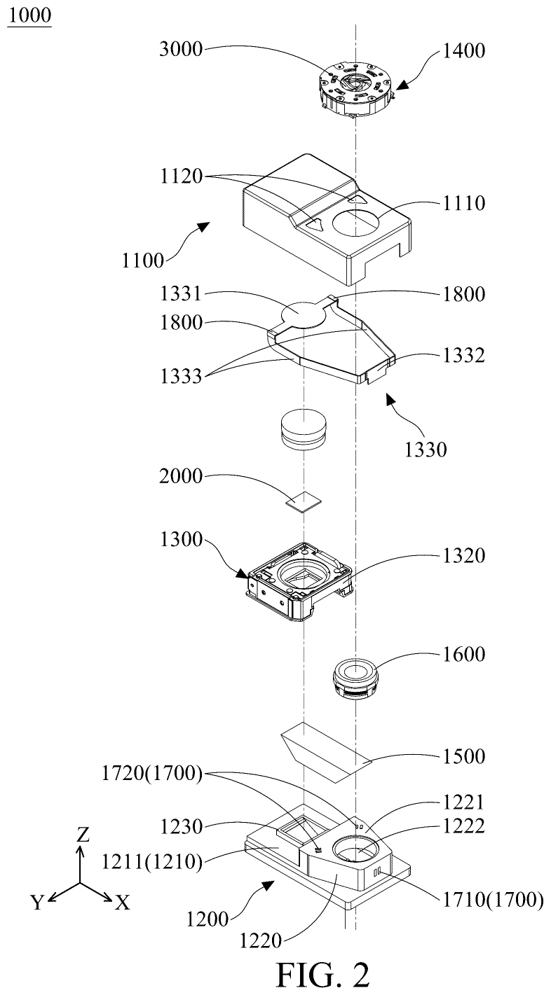

FIG. 1 shows a perspective view of an optical system 1000 according to some embodiments of the present disclosure. FIG. 2 shows an exploded view of the optical system 1000 in accordance with some embodiments of the present disclosure. The overall structure of the optical system 1000 is described in detail below. Please refer to FIG. 1 and FIG. 2.

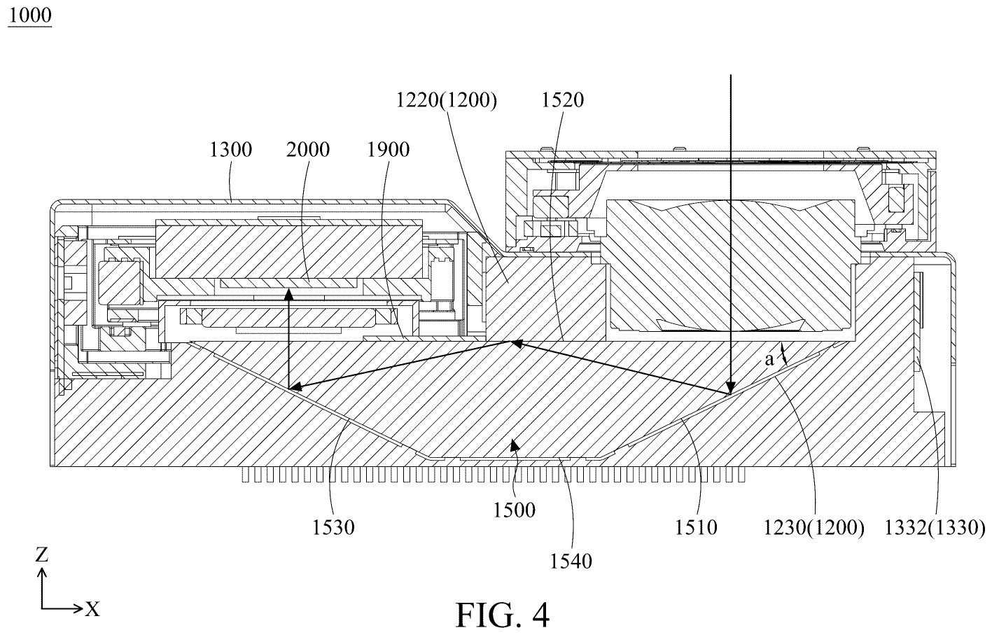

According to some embodiments of the present disclosure, the optical system 1000 includes a housing 1100, a base 1200, a first optical module 1300, a second optical module 1400, a first optical unit 1500, and a second optical unit. 1600, a connecting circuit component 1700, a pair of structural strengthening elements 1800, and a shielding element 1900 (FIG. 4).

According to some embodiments of the present disclosure, the housing 1100 is fixedly connected to the base 1200 to form an accommodating space for accommodating part of the components of the optical system 1000. The housing 1100 includes an opening 1110 and two openings 1120, the details of which is described in detail later.

According to some embodiments of the present disclosure, the base 1200 includes a flat structure 1210, a protruding structure 1220 and a receiving portion 1230. The flat structure 1210 includes a first surface 1211. The protruding structure 1220 includes a second surface 1221 and a receiving space 1222. The first surface 1211 faces the first optical module 1300, and the second surface 1221 faces the second optical module 1400. The first surface 1211 and the second surface 1221 face the same direction.

According to some embodiments of the present disclosure, the first optical module 1300 is connected to the base 1200. In detail, the first optical module 1300 is disposed on the flat structure 1210 and the receiving portion 1230. The first optical module 1300 is configured to connect a first optical element 2000. The first optical element 2000 has a first optical axis, and the first optical axis is substantially parallel to the Z-axis.

According to some embodiments of the present disclosure, the first surface 1211 of the flat structure 1210 and the second surface 1221 of the protruding structure 1220 are perpendicular to the first optical axis of the first optical element 2000. When viewed along the direction of the first optical axis (which is parallel to the Z-axis), the protruding structure 1220 has a trapezoidal shape. The first optical unit 1500 is disposed in the base 1200. Specifically, the first optical unit 1500 is received in the receiving portion 1230 of the base 1200.

According to some embodiments of the present disclosure, the receiving space 1222 of the protruding structure 1220 is interconnected to the receiving portion 1230 receiving the first optical unit 1500 in the direction of the first optical axis (which is parallel to the Z-axis). It should be noted that the center of the second optical element 3000 and the opening 1110 of the housing 1100 and the center of the second optical unit 1600 are aligned with each other in the direction of the Z-axis.

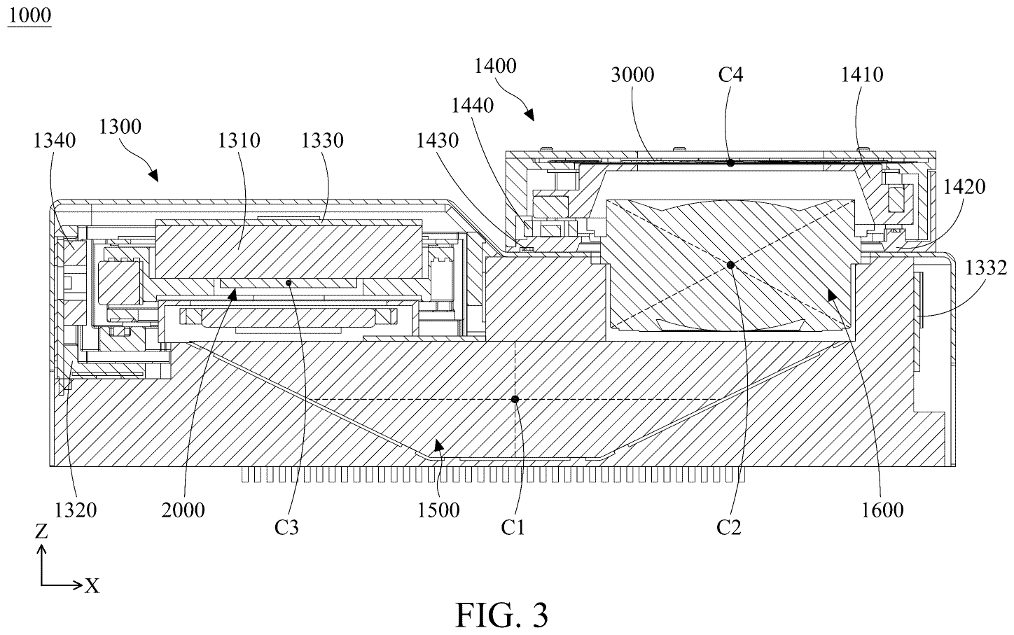

Please temporarily refer to FIG. 3, which shows a cross-sectional view of the optical system 1000 taken along line A-A of FIG. 1. The first optical module 1300 has functions of Auto Focus (AF) and Optical Image Stabilization (OIS). As shown in FIG. 3, the first optical module 1300 includes a first movable portion 1310, a first base 1320, a first circuit component 1330 and a first driving component 1340.

According to some embodiments of the present disclosure, the first movable portion 1310 is configured to connect the first optical element 2000. The first movable portion 1310 is movable relative to the first base 1320. The first circuit component 1330 is configured to electrically connect to an external circuit. The first driving component 1340 is electrically connected to the first circuit component 1330.

According to some embodiments of the present disclosure, the first driving component 1340 is configured to drive the first movable portion 1310 to move relative to the first base 1320 in the direction of the first optical axis (which is parallel to the Z-axis) to achieve the auto-focus function. The first driving component 1340 is also configured to drive the first movable portion 1310 to move in the X-axis (first axis) and the Y-axis (second axis) relative to the first base 1320 to achieve the OIS function. The first optical axis (which is parallel to the Z-axis), the first axis (X-axis) and the second axis (Y-axis) are perpendicular to each other.

As shown in FIG. 3, only one of the coils of the first driving component 1340 is used to represent the first driving component 1340. Those skilled in the art should understand that the first driving component 1340 of the first optical module 1300 has the elements that enables the first optical element 2000 to achieve AF and OIS functions.

Please refer back to FIG. 2. As shown in FIG. 2, the first circuit component 1330 includes a movable portion fixed end 1331, a fixed portion fixed end 1332 and two flexible portions 1333. When the first movable portion 1310 (FIG. 3) is driven, the movable portion fixed end 1331 is movable relative to the first base 1320 and the fixed portion fixed end 1332, and when viewed along the first axis (X-axis), the movable portion fixed end 1331 of the first circuit component 1330 does not overlap with the protruding structure 1220 of the base 1200.

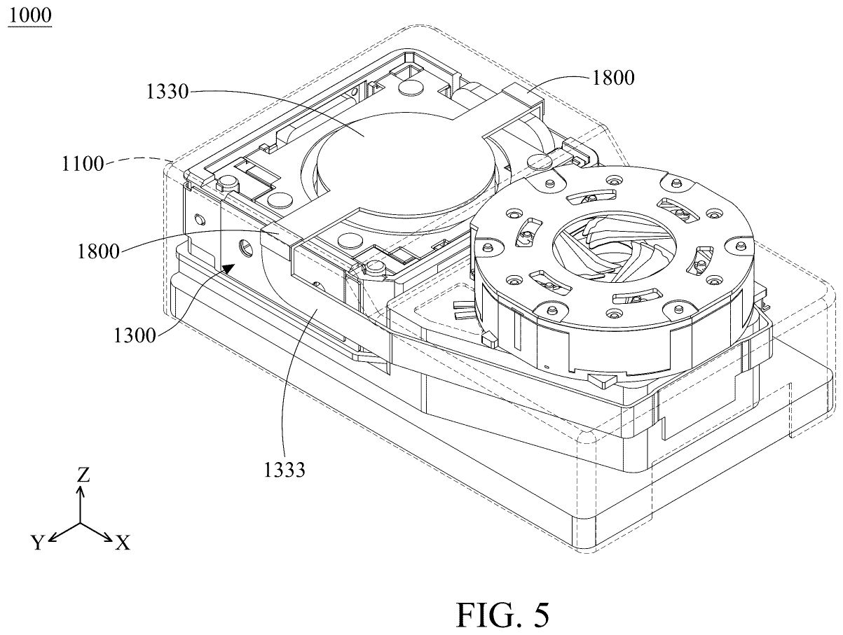

According to some embodiments of the present disclosure, the movable portion fixed end 1331 is movably connected to the fixed portion fixed end 1332 via the flexible portion 1333. When viewed along the first optical axis (which is parallel to the Z-axis), the flexible portion 1333 is at least partially located on two opposite sides of the first optical module 1300, the first optical module 1300 has a polygonal structure, and both opposite sides of the first optical module 1300 are parallel to the first axis. In addition, the flexible portion 1333 surrounds the protruding structure 1220 of the base 1200 or may partially contact the protruding structure 1220 of the base 1200. That is, when viewed along the first optical axis, the first circuit component 1330 and the protruding structure 1220 of the base 1200 may not overlap, and the flexible portion 1333 may be positioned between the base 1200 and the protruding structure 1220. This allows for efficient use of the space inside the housing 1100 and increases the freedom of movement of the first movable portion 1310 along the first axis (X-axis) and the second axis (Y-axis). The details are more clearly shown in FIG. 5.

Please temporarily refer to FIG. 3. As shown in FIG. 3, the second optical module 1400 includes a second movable portion 1410, a second base 1420, a second circuit component 1430 and a second driving component 1440. The second movable portion 1410 is connected to the second optical element 3000.

According to some embodiments of the present disclosure, the second movable portion 1410 is movable relative to the second base 1420. The second circuit component 1430 is configured to connect to an external circuit via the second junction 1720 (FIG. 2) of the connecting circuit component 1700.

According to some embodiments of the present disclosure, the second circuit component 1430 is a terminal partially embedded in the second base 1420, wherein as seen more clearly in FIG. 1, a portion of the second circuit component 1430 is exposed through the opening 1120 of the housing 1100 (FIG. 2), which is to be connected to the connecting circuit component 1700 (FIG. 2). The second driving component 1440 is configured to drive the second movable portion 1410 to move relative to the second base 1420.

Please refer back to FIG. 2. According to some embodiments of the present disclosure, the second optical module 1400 is disposed on the housing 1100. The second optical module 1400 is connected to the second optical element 3000. The second optical element 3000 has a second optical axis, and the second optical axis is substantially parallel to the first optical axis and the Z-axis.

In this embodiment, the first optical unit 1500 may be an optical element that changes the direction of light, such as a prism. The second optical unit 1600 may be an optical element including a plurality of lenses. The second optical unit 1600 is disposed in the receiving space 1222 of the protruding structure 1220. The first optical element 2000 may be an image sensor. The second optical element 3000 may be an aperture, blades, or other optical element that controls the amount of light entering.

According to some embodiments of the present disclosure, when light enters the optical system 1000, it first passes through the second optical element 3000 connected in the second optical module 1400 that controls the amount of light entering, and then passes through the second optical unit 1600. Then, the light enters the first optical unit 1500 from the second optical unit 1600. When light passes through the first optical unit 1500, its traveling direction changes.

For example, in the embodiment shown in FIG. 2, light enters the first optical unit 1500 from the −Z direction and leaves the first optical unit 1500 from the +Z direction. Then, the light will enter the first optical module 1300 from the +Z direction to enter the first optical element 2000 which is an image sensor.

According to some embodiments of the present disclosure, the connecting circuit component 1700 is fixedly connected to the base 1200. To be more specific, the connecting circuit component 1700 is a terminal embedded within the base 1200 through insert molding. The connecting circuit component 1700 includes a first junction 1710 and a second junction 1720.

According to some embodiments of the present disclosure, the first junction 1710 and the second junction 1720 respectively correspond to the first circuit component 1330 and the second circuit component 1430 (FIG. 1). The first circuit component 1330 is electrically connected to the external circuit via the first junction 1710 of the connecting circuit component 1700. The second circuit component 1430 (FIG. 1) is electrically connected to the external circuit via the second junction 1720 of the connecting circuit component 1700.

According to some embodiments of the present disclosure, when viewed along the first optical axis (which is parallel to the Z-axis), the first junction 1710 and the second junction 1720 are located on the same side of the base 1200. For example, the first junction 1710 and the second junction 1720 are all on the upper side of the base 1200 in FIG. 2, that is, the side of the base 1200 that carries the first optical module 1300 and the second optical module 1400.

According to some embodiments of the present disclosure, two structural strengthening elements 1800 are respectively placed at the bending points of the flexible portion 1333 of the first circuit component 1330 to enhance the structural stability of the flexible portion 1333. The structural strengthening elements 1800 may be made of metal material, and their structure can be seen more clearly in FIG. 5.

Please refer to FIG. 3. As shown in FIG. 3, the second optical unit 1600 corresponds to the first optical unit 1500, and there is a gap between the first optical unit 1500 and the second optical unit 1600. The center C1 of the first optical unit 1500, the center C2 of the second optical unit 1600, the center C3 of the first optical element 2000 and the center C4 of the second optical element 3000 can be seen from FIG. 3.

As shown in FIG. 3, when viewed along the first optical axis (which is parallel to the Z-axis), the center C1 of the first optical unit 1500 does not overlap with the center C2 of the second optical unit 1600. When viewed along the first optical axis (which is parallel to the Z-axis), the center C3 of the first optical element 2000 does not overlap with the center C1 of the first optical unit 1500. When viewed along the first optical axis (which is parallel to the Z-axis), the center C1 of the first optical unit 1500 is located between the fixed portion fixed end 1332 of the first circuit component 1330 and the center C3 of the first optical element 2000.

As shown in FIG. 3, when viewed along the first optical axis (which is parallel to the Z-axis), the center C3 of the first optical element 2000 and the center C1 of the first optical unit 1500 are arranged along the first axis (X-axis). When viewed along the first optical axis (which is parallel to the Z-axis), the first circuit component 1330 and the center C3 of the first optical element 2000 at least partially overlap, and the first circuit component 1330 and the center C1 of the first optical unit 1500 do not overlap.

As shown in FIG. 3, when viewed along the first optical axis (which is parallel to the Z-axis), first optical unit 1500 and the center C3 of the first optical element 2000 partially overlap, and the first optical unit 1500 overlaps with the center C4 of the second optical element 2000. When viewed along the first axis (X-axis), the first optical element 2000 and the second optical unit 1600 at least partially overlap. The above structural design and component arrangement allow the overall height of the optical system 1000 along the first optical axis (Z-axis) to be reduced, achieving the goal of miniaturization.

FIG. 4 shows a cross-sectional view of the optical system 1000, in which the light path entering the optical system 1000 is indicated by arrows. As shown in FIG. 4, the shielding element 1900 is disposed between the first optical unit 1500 and the first optical module 1300 in the direction of the first optical axis (which is parallel to the Z-axis) to absorb stray light from the first optical unit 1500. The shielding element 1900 can be made of light-absorbing material. As shown in FIG. 4, one side of the shielding element 1900 abuts the protruding structure 1220 of the base 1200.

In FIG. 4, arrows representing the path light travels in optical system 1000 can be seen. As shown in FIG. 4, there is a gap between the first optical unit 1500 and the receiving portion 1230 of the base 1200 to prevent stray light in the optical system. As shown in FIG. 4, the first optical unit 1500 includes a first optical surface 1510, a second optical surface 1520, a third optical surface 1530 and a fourth optical surface 1540.

According to some embodiments of the present disclosure, the first light surface 1510 is a first reflective surface for light entering the prism (first optical unit 1500). The second light surface 1520 is a second reflective surface for light entering the prism (first optical unit 1500). The third light surface 1530 is a third reflective surface for light entering the prism (first optical unit 1500). The fourth optical surface 1540 is the bottom surface of the prism (the first optical unit 1500), and the fourth optical surface 1540 is parallel to the second optical surface 1520.

According to some embodiments of the present disclosure, the angle a between the first optical surface 1510 and the second optical surface 1520 is less than 45 degrees. It should be understood that the size of the first optical unit 1500 of this invention can be designed according to the varying sizes of the first optical element 2000 to meet specific requirements.

In addition, it can also be seen in FIG. 4 that when viewed along the first axis (X-axis), the fixed portion fixed end 1332 of the first circuit component 1330 at least partially overlaps the first optical unit 1500.

FIG. 5 shows a perspective view of the optical system 1000 according to some embodiments of the present disclosure, where the housing 1100 is shown in dashed lines for illustrative purposes. As shown in FIG. 5, when viewed along the first optical axis (which is parallel to the Z-axis), the flexible portions 1333 are at least partially located on two opposite sides of the first optical module 1300 with a polygonal structure, both of which are parallel to the first axis (X-axis).

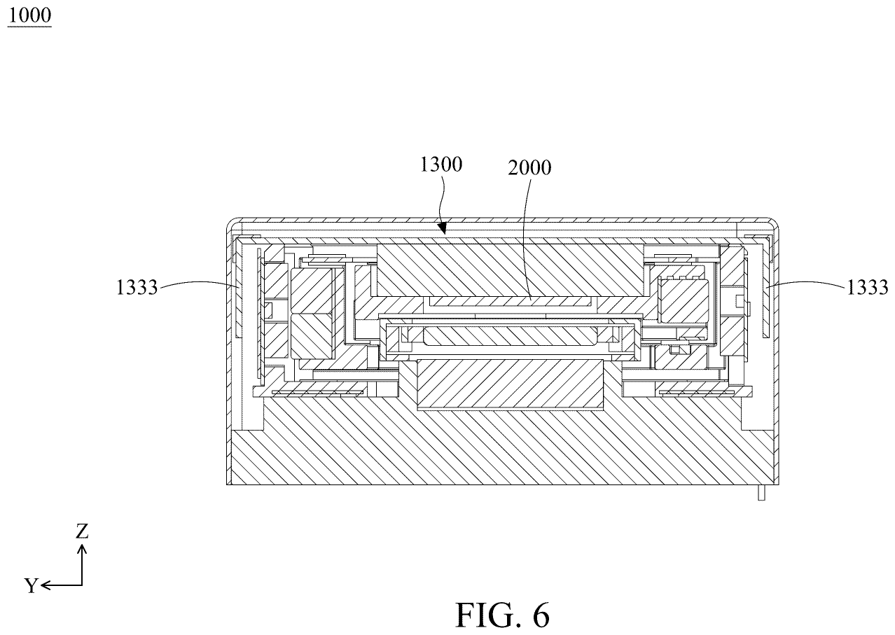

FIG. 6 shows a cross-sectional view of the optical system 1000 taken along line B-B of FIG. 1. As shown in FIG. 6, when viewed along the second axis (Y-axis), the flexible portion 1333 of the first circuit component 1330 at least partially overlaps the first optical element 2000.

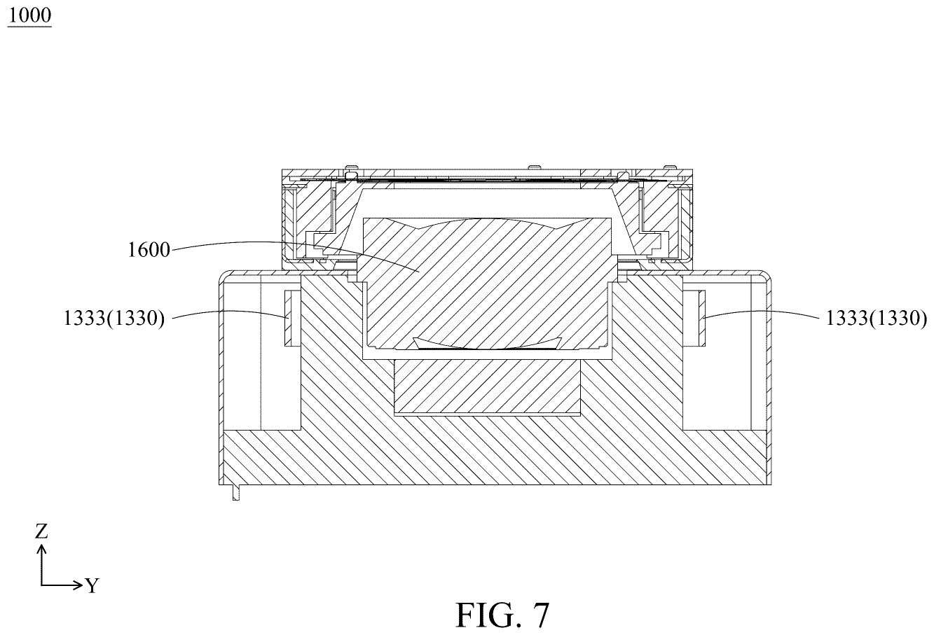

FIG. 7 shows a cross-sectional view of the optical system 1000 taken along line C-C of FIG. 1. As shown in FIG. 7, when viewed along the second axis (Y-axis), the flexible portion 1333 of the first circuit component 1330 at least partially overlaps the second optical unit 1600.

In summary, the present invention provides an optical system in which the second optical module, which is connected to the aperture (the second optical element), the first optical unit, which changes the optical path, and the first optical module, which is connected to the image sensor (the first optical element), are all positioned on the same side of the base. This arrangement allows the light entering and exiting the optical system to be parallel to each other but in opposite directions.

The benefit of this configuration is that both the first and second optical modules are located on the same side of the base, reducing the number of workstations required during the manufacturing process. Furthermore, since the first and second optical modules are on the same side of the base, internal space can be optimized when integrating the optical system into devices such as mobile phones, thus achieving the goal of miniaturization.

Although the embodiments and advantages of the present disclosure have been described above, it should be understood that any person of ordinary skill in the art may make modifications, substitutions, and enhancements without departing from the spirit and scope of the present disclosure. Moreover, the scope of protection of this disclosure is not limited to the specific embodiments of processes, machines, manufacture, compositions of matter, devices, methods, and steps described in the specification. Any person of ordinary skill in the art can understand from the present disclosure processes, machines, manufacture, compositions of matter, devices, methods, and steps, whether currently developed or developed in the future, that perform substantially the same function or achieve substantially the same result as the embodiments described herein, and such can be used in accordance with the present disclosure. Therefore, the scope of protection of the present disclosure includes the above-mentioned processes, machines, manufacture, compositions of matter, devices, methods, and steps. Furthermore, each claim constitutes a separate embodiment, and the scope of the present disclosure also includes combinations of the various claims and embodiments.

What is claimed is:

1. An optical system, comprising:
a first optical module for connecting a first optical element;
a base, wherein the first optical module is connected to the base; and
a first optical unit disposed on the base.

2. The optical system as claimed in claim 1, wherein the first optical module comprises:
a first movable portion for connecting the first optical element; and
a first base, wherein the first movable portion is movable relative to the first base.

3. The optical system as claimed in claim 2, wherein the first optical module further comprises a first circuit component configured to electrically connect an external circuit, the first circuit component comprises a movable portion fixed end, the movable portion fixed end is movable relative to the first base.

4. The optical system as claimed in claim 3, wherein the first circuit component further comprises a fixed portion fixed end, wherein the movable portion fixed end is movable relative to the fixed portion fixed end.

5. The optical system as claimed in claim 4, wherein the first circuit component further comprises a flexible portion, wherein the movable portion fixed end is movably connected to the fixed portion fixed end via the flexible portion.

6. The optical system as claimed in claim 5, wherein when viewed along a first optical axis of the first optical module, a center of the first optical element does not overlap with a center of the first optical unit.

7. The optical system as claimed in claim 6, wherein when viewed along the first optical axis, the center of the first optical unit is located between the first circuit component and the center of the first optical element.

8. The optical system as claimed in claim 6, wherein when viewed along the first optical axis, the center of the first optical element and the center of the first optical unit are arranged along a first axis, and the first axis is perpendicular to the first optical axis.

9. The optical system as claimed in claim 8, wherein when viewed along the first optical axis, the flexible portion is at least partially located on a side of the first optical module having a polygonal structure, and the side of the first optical module is parallel to the first axis.

10. The optical system as claimed in claim 8, wherein when viewed along the first optical axis, the first circuit component at least partially overlaps the center of the first optical element, and the first circuit component and the center of the first optical unit do not overlap.

11. The optical system as claimed in claim 8, further comprising a second optical module and a housing, the second optical module is connected to a second optical element, and the second optical module is disposed on the housing, the housing is connected to the base.

12. The optical system as claimed in claim 11, wherein the base comprises a first surface and a second surface, the first surface faces the first optical module, the first surface is perpendicular to the first optical axis, the second surface faces the second optical module, and the first surface and the second surface face the same direction.

13. The optical system as claimed in claim 11, wherein when viewed along the first optical axis, the first optical unit partially overlaps the center of the first optical element, and the first optical unit overlaps the center of the second optical element.

14. The optical system as claimed in claim 11, further comprising a connecting circuit component, wherein the second optical module comprises:
a second movable portion connected to the second optical element;
a second base, wherein the second movable portion is movable relative to the second base; and
a second circuit component for connecting to the external circuit;
wherein the second circuit component is electrically connected to the external circuit via the connecting circuit component, and the connecting circuit component is fixedly connected to the base.

15. The optical system as claimed in claim 14, wherein the first circuit component is electrically connected to the external circuit via the connecting circuit component, the connecting circuit component comprises a first junction and a second junction, and the first junction and the second junction respectively correspond to the first circuit component and the second circuit component.

16. The optical system as claimed in claim 15, wherein when viewed along the first optical axis, the first junction and the second junction are located on the same side of the base.

17. The optical system as claimed in claim 11, wherein when viewed along the first axis, the fixed portion fixed end at least partially overlaps the first optical unit, when viewed along a second axis, the flexible portion at least partially overlaps the first optical element, the second axis is perpendicular to the first optical axis, and the second axis is perpendicular to the first axis.

18. The optical system as claimed in claim 17, further comprising a second optical unit corresponding to the first optical unit, and a gap is present between the first optical unit and the second optical unit;
wherein when viewed along the first optical axis, the center of the first optical unit and a center of the second optical unit do not overlap;
wherein when viewed along the first axis, the first optical element and the second optical unit at least partially overlap;
wherein when viewed along the second axis, the flexible portion at least partially overlaps the second optical unit.

19. The optical system as claimed in claim 11, wherein the base comprises a protruding structure, the protruding structure has a trapezoidal shape when viewed along the first optical axis, and the flexible portion surrounds the protruding structure.

20. The optical system as claimed in claim 11, further comprising a shielding element disposed between the first optical unit and the first optical module in the direction of the first optical axis to absorb stray light from the first optical unit.
